(19) United States
(12) Patent Application Publication
(10) Pub. No.: US 2002/0059052 A1
(43) Pub. Date: May 16, 2002

(54) Co-simulation of network components

(75) Inventors: Noam Bloch, Bat Shlomo (IL); Hillel Chapman, Mahanayim (IL)

Correspondence Address: Ladas & Parry, 26 West 61th Street, New York, NY, 10023, US

(73) Assignee: MELLANOX TECHNOLOGIES LTD.

(21) Appl. No.: 09/951,191

(22) Filed: Sep. 12, 2001

Related U.S. Application Data
(60) Provisional application No. 60/232,015, filed on Sep. 12, 2000.

(51) Int. Cl. G06F 17/50

(52) U.S. Cl. 703/13

(57) ABSTRACT

A method for simulation includes establishing a network connection between first and second simulators, which are respectively configured to simulate operation of first and second devices in mutual communication over a link having a link clock. The first simulator receives an input frame sent over the network connection from the second simulator in the course of the simulated operation of the second device over multiple cycles of the link clock and processes the input data to simulate the operation of the first device so as to generate an output frame comprising output data. The first simulator then passes the output frame to the second simulator over the network connection for processing by the second simulator.

### CROSS-REFERENCE TO RELATED APPLICATION

This application claims the benefit of U.S. Provisional Patent Application No. 60/232,015, filed Sep. 12, 2000, which is incorporated herein by reference.

### FIELD OF THE INVENTION

The present invention relates generally to simulation testing of electrical systems, and specifically to distributed simulation of multiple electrical components operating simultaneously.

### BACKGROUND OF THE INVENTION

Methods of parallel and distributed simulation are known in the art. Such methods are used to model multiple, interacting devices, such as the components of a network of computers or communication devices. Simulations of this sort must therefore deal with both the internal workings of each of the processes, and with communications between the different processes.

Parsec is a dedicated computer language that was designed to simulate multi-component systems. It is described, for example, by Bagrodia et al., in “Parsec: A Parallel Simulation Environment for Complex Systems,” published in IEEE Computer 31:10 (1998), pages 77-85, which is incorporated herein by reference. Parsec allows a simulation model to be partitioned by allocating simulation entities among multiple processors. The partitioned simulation model, written as a unified program in Parsec, is then compiled and run in parallel on the multiple processors. Parsec has been used in applications such as switch-level circuit simulations and wireless network models. Further information regarding Parsec is available on the World Wide Web at pcl.cs.ucla.edu/projects/parsec/.

Parsec uses a discrete-event approach to simulation, based on a process interaction model. An object (also referred to as a physical process) or set of objects in the physical system of interest is represented by an entity (or logical process) in the simulation. Interactions among the physical processes, which are defined as events, are modeled by message exchanges among the corresponding logical processes. Each message carries a logical timestamp, matching the time at which the corresponding event occurred in the physical system. In execution of the discrete-event model, all events in the system must be dealt with in their strict timestamp order. Therefore, Parsec requires that a synchronization algorithm be used in conjunction with the distributed simulation model, in order to maintain the proper event ordering among all of the participating entities.

Distributed simulations are also used in military applications, typically for simulating the interaction of different weapon systems and other components on a battlefield. For example, Fujimoto and Weatherly describe methods for interconnecting multiple autonomous wargame simulations into “federations,” in “Time Management in the DoD High Level Architecture,” which was presented at the 1996 Workshop on Parallel and Distributed Simulation and is available at www.cc.gatech.edu/computing/pads/PAPERS/HLA-PADS96.pdf. The architecture described in this article requires that all of the federated simulators share a common run-time infrastructure, which includes synchronous timing and messaging services to ensure that events are delivered and processed by all of the simulators in the proper order.

Other methods of distributed simulation are cycle-based. In these models, all of the elements of the multi-component system are subject to the same cycle clock, and exchange information at each cycle of the simulation. For example, U.S. Pat. No. 5,960,188, to Linke et al., which is incorporated herein by reference, describes a method for modeling electrical interconnections in a cycle-based simulator. As noted in this patent, cycle-based simulators, in contrast to event-based simulators, build on the characteristic of large electrical systems that they are usually synchronous in nature. All behavior within the system occurs within a given, regular period of time that is regulated by clock signal transitions, or cycles. U.S. Pat. No. 5,960,188 provides a software model based on “nodes,” representing circuit elements, which assert and acquire information via “wires,” representing interconnections, at each cycle of the simulation clock.

### SUMMARY OF THE INVENTION

It is an object of the present invention to provide improved methods and apparatus for parallel and distributed simulation of multi-component systems.

It is a further object of some aspects of the present invention to provide methods for simulation of multiple components that communicate via a packet switching network.

It is yet a further object of some aspects of the present invention to enable co-simulation of multiple components, which may be under development by different vendors, without requiring disclosure of the inner workings and design of the components.

Preferred embodiments of the present invention are based on the observation that packet-switching network components typically interact with one another only on time scales that are very large compared to the inner clock cycle of the devices themselves, and are usually large even compared to the link clock cycle of the communication link connecting the components. Therefore, the processors that simulate these components need to exchange information once in a period of multiple link clock cycles. Furthermore, the interfaces among the components in the simulated system are typically limited to a small number of signals that change no more than once per link clock cycle.

Thus, in preferred embodiments of the present invention, multiple simulators, simulating the operation of multiple, linked devices, are configured to exchange data, typically using network connections between the simulators. Preferably, each of the simulators maintains a dedicated process thread for each of the links of the device that it is simulating with the other simulated devices. The threads send and receive data frames containing the data that would be exchanged in actual operation between the devices under simulation. After receiving an input frame from another of the simulators, each of the threads, at each cycle of the simulated link clock, reads and processes a data symbol from the input frame and writes a symbol to an output frame as appropriate. When the output frame reaches a predetermined size, which is preferably set as a parameter of the simulation, the simulator passes the frame to the other simulator, to serve as its input frame. This process of frame exchange continues indefinitely, for as long as the simulation is running.

Preferably, the data frames comprise files, which are successively stored in an assigned directory of a file system used by the simulators. The file size and the number of successive input files that are held in the directory, besides serving as parameters for coordination among the different simulators, also emulate the latency of the actual network in the system under simulation. Alternatively, other methods of data framing and other types of communication sockets, as are known in the art, may be used in communications among the simulators. While preferred simulation methods are described herein, for the sake of simplicity, mainly with reference to simulations involving two simulators, these methods may be extended to groups of three or more simulators, linked in substantially any topology, in a straightforward manner.

Preferred embodiments of the present invention thus allow distributed co-simulation of multiple components on different simulators, with only minimal constraints on the simulators themselves. There is no need for synchronization of the simulators at the event or cycle level, and the amount of communication traffic among the different simulation processes is very small by comparison with methods and systems of distributed simulation that are known in the art. The effects of temporal imbalances among the different simulators are mitigated inherently by the frame exchange mechanism described above. The simulators may thus be of different types, even belonging to different companies, and may be connected by substantially any kind of communication link, including the Internet. The methods of the present invention enable the simulation to take place at substantially any stage of the process of design of the components, without requiring the companies to exchange confidential information or to disclose details of their designs. These methods can thus be used to co-simulate device models at different levels of abstraction, including high-level performance evaluation models, logic-design models written in HDL (hardware description language) and verification stubs.

There is therefore provided, in accordance with a preferred embodiment of the present invention, a method for simulation, including:

establishing a network connection between first and second simulators, which are respectively configured to simulate operation of first and second devices in mutual communication over a link having a link clock;

receiving at the first simulator an input frame sent over the network connection, the input frame including input data generated by the second simulator in the course of the simulated operation of the second device over multiple cycles of the link clock for transmission via the link to the first device;

processing the input data using the first simulator to simulate the operation of the first device over multiple cycles of the link clock and thus to generate an output frame including output data; and

passing the output frame from the first simulator to the second simulator over the network connection for processing by the second simulator in the simulated operation of the second device.

In a preferred embodiment, establishing the network connection includes choosing file names and directory and accessing them through a local area network (LAN). In another preferred embodiment, the first and second simulators are located at respective sites, remote from one another, and establishing the network connection includes accessing the files over the Internet.

The first and second simulators may be configured to simulate the first and second devices using substantially different, respective first and second simulation software tools. In one preferred embodiment, the first simulation tool includes a hardware design language tool, while the second simulation tool includes a high-level modeling tool. In another preferred embodiment, the first simulation tool includes a device simulator, while the second simulation tool includes a test generator or a verification stub, which is configured to generate the input data so as to verify behavior of the first device.

Preferably, receiving the input frame includes receiving a file, and the input data include input symbols arranged in sequence in the file. Further preferably, the output frame includes an output file, and the output data include output symbols, and processing the input data includes reading, at each of the cycles of the link clock in the simulated operation of the first device, one of the input symbols from the input file, and writing one of the output symbols to the output file. Most preferably, passing the output frame includes passing the output file after the first simulator has written a predetermined number of the symbols to the output file.

Alternatively or additionally, establishing the network connection includes opening communication sockets, and receiving the input frame and passing the output frame include receiving and passing the frames using the sockets.

Preferably, processing the input data includes generating the output data over a number of the cycles of the link clock that is selected responsive to a latency of the mutual communication between the first and second devices in the simulated operation thereof.

Further preferably, receiving the input frame includes receiving an input succession of input frames, and wherein processing the input data includes generating an output succession of output frames, and passing the output frame includes passing the output frames in the output succession while receiving the input frames in the input succession. Most preferably, receiving the succession of input frames includes holding at least a second one of the input frames in a memory while processing a first one of the input frames.

In a preferred embodiment, receiving the input frame includes receiving input frames from a plurality of other simulators, including the second simulator, and processing the input data includes generating multiple output frames, and passing the output frame includes passing the output frames to the plurality of other simulators.

There is also provided, in accordance with a preferred embodiment of the present invention, a method for simulation, including:

establishing a network connection between first and second simulators operated respectively by different first and second business entities in development of first and second devices, the first and second simulators being respectively configured to simulate operation of first and second devices in mutual communication over a link;

receiving at the first simulator an input frame sent over the network connection, the input frame including input data generated by the second simulator in the course of the simulated operation of the second device for transmission via the link to the first device;

processing the input data using the first simulator to simulate the operation of the first device and thus to generate an output frame including output data; and

passing the output frame from the first simulator to the second simulator over the network connection for processing by the second simulator in the simulated operation of the second device.

In a preferred embodiment, establishing the network connection includes establishing the connection between facilities of the first and second business entities.

Preferably, establishing the network connection includes linking the first and second simulators substantially without divulging confidential information embodied in a simulation model of the first device run by the first simulator to the second business entity.

There is additionally provided, in accordance with a preferred embodiment of the present invention, simulation apparatus, including a first simulation processor, which is configured to simulate operation of a first device and is adapted to establish a network connection with a second simulation processor, configured to simulate operation of a second device, so as to model communication between the first and second devices over a link having a link clock, the first simulation processor being further adapted to receive an input frame sent over the network connection, the input frame including input data generated by the second simulation processor in the course of the simulated operation of the second device over multiple cycles of the link clock for transmission via the link to the first device, to process the input data so as to simulate the operation of the first device over multiple cycles of the link clock and thus to generate an output frame including output data, and to pass the output frame to the second simulation processor over the network connection for processing by the second simulation processor in the simulated operation of the second device.

Preferably, the apparatus includes a memory, which is adapted to hold at least a second one of the input frames while the first simulation processor processes a first one of the input frames.

There is further provided, in accordance with a preferred embodiment of the present invention, apparatus for simulation, including first and second simulators operated respectively by different first and second business entities in development of first and second devices, the first and second simulators being connected by a network connection and being respectively configured to simulate operation of first and second devices in mutual communication over a link, such that upon receiving over the network connection an input frame including input data generated by the second simulator in the course of the simulated operation of the second device for transmission via the link to the first device, the first simulator is adapted to process the input data to simulate the operation of the first device and thus to generate an output frame including output data, and to pass the output frame to the second simulator over the network connection for processing by the second simulator in the simulated operation of the second device.

There is moreover provided, in accordance with a preferred embodiment of the present invention, a computer software product, including a computer-readable medium in which program instructions are recorded, which instructions, when read by a first computer simulating operation of a first device, cause the computer to establish a network connection with a second computer, simulating operation of a second device, so as to model communication between the first and second devices over a link having a link clock, so that upon receiving an input frame sent over the network connection, the input frame including input data generated by the second computer in the course of the simulated operation of the second device over multiple cycles of the link clock for transmission via the link to the first device, the first computer processes the input data to simulate the operation of the first device over multiple cycles of the link clock and thus to generate an output frame including output data, and passes the output frame to the second computer over the network connection for processing by the second computer in the simulated operation of the second device.

There is furthermore provided, in accordance with a preferred embodiment of the present invention, a computer software product, including a computer-readable medium in which program instructions are recorded, which instructions, when read by a first computer operated by a first business entity in development of a first device, cause the first computer to establish a network connection with a second simulator operated by a different, second business entity in development a second device, the first and second computers being respectively configured to simulate operation of the first and second devices in mutual communication over a link, so that upon receiving an input frame sent over the network connection, the input frame including input data generated by the second computer in the course of the simulated operation of the second device for transmission via the link to the first device, the first computer processes the input data to simulate the operation of the first device and thus to generate an output frame including output data, and passes the output frame to the second computer over the network connection for processing by the second computer in the simulated operation of the second device.

The present invention will be more fully understood from the following detailed description of the preferred embodiments thereof, taken together with the drawings in which:

### BRIEF DESCRIPTION OF THE DRAWINGS

FIG. 1 is a block diagram that schematically illustrates a system for co-simulation, in accordance with a preferred embodiment of the present invention;

FIG. 2 is a timing diagram that schematically illustrates a method of data framing used in co-simulation, in accordance with a preferred embodiment of the present invention; and

FIG. 3 is a flow chart that schematically illustrates a method for co-simulation, in accordance with a preferred embodiment of the present invention.

### DETAILED DESCRIPTION OF PREFERRED EMBODIMENTS

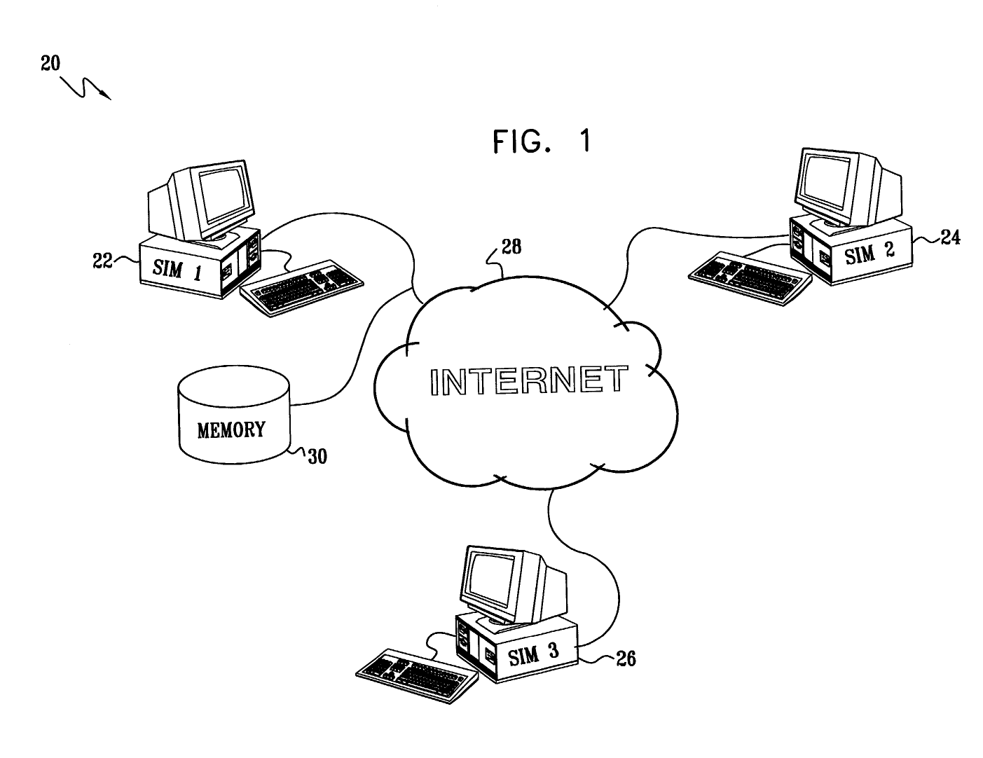

FIG. 1 is a block diagram that schematically illustrates a system 20 for distributed co-simulation, in accordance with a preferred embodiment of the present invention. System 20 comprises a plurality of simulators 22, 24, 26, interconnected via a network 28, which is referred to herein as the simulation network. Network 28 may comprise substantially any suitable type of computer network known in the art, such as a local area network (LAN), the Internet, or a set of point-to-point links among the simulators.

Simulators 22, 24, 26 typically comprise general-purpose computers, running under the control of simulation software, as is known in the art. Each of the simulators models the behavior of a respective device, which is designed to communicate over a network, preferably a packet-switched network, referred to herein as the simulated network. System 20 uses simulation network 28 to emulate the interaction of the actual devices over the simulated network. Thus, for example, each of simulators 22, 24 and 26 may model a component used in an InfiniBand™ switch fabric (the simulated network, in this case), such as a switch or channel adapter. In this case, communications among the simulators over network 28 models the interaction of the switches or channel adapters over the InfiniBand fabric.

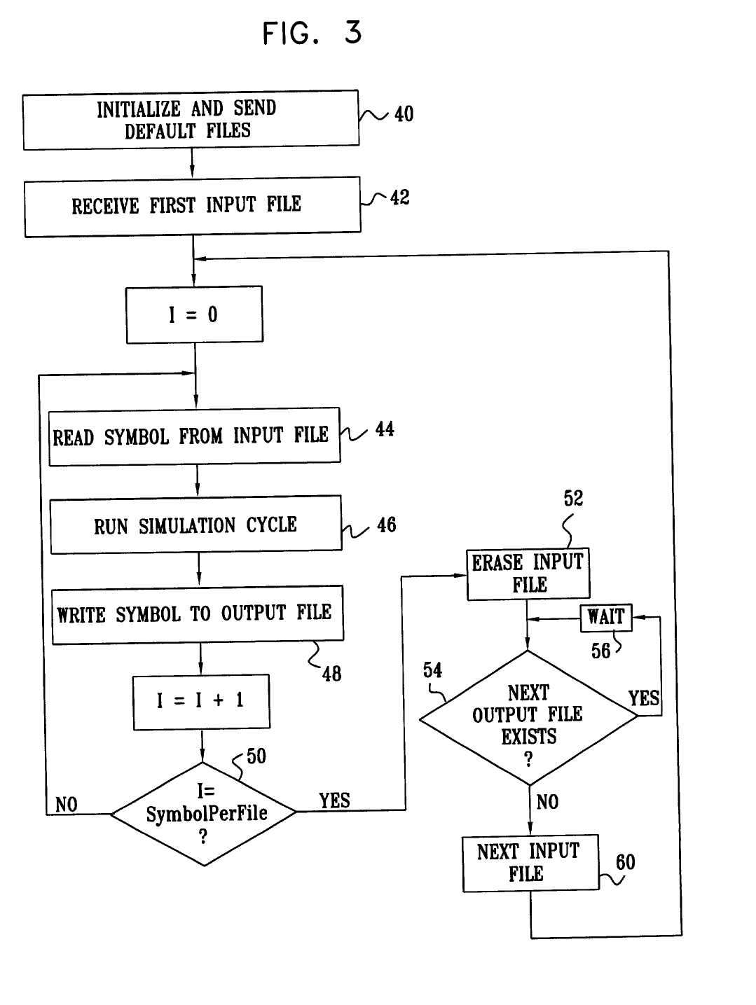

Each of simulators 22, 24, 26 runs its own simulation software, which may be of any suitable type known in the art, whether commercially available or custom-developed for the particular simulator in question. All of the simulators, in addition, run a common communication protocol for the purposes of co-simulation of the components that they are modeling. This protocol is described hereinbelow with reference to FIG. 3. The protocol and other tools needed for co-simulation may be provided as part of a commercial simulation package, or they may alternatively be added on to an existing commercial or custom-developed simulator. The co-simulation software (either as part of the package or as add-on) may be downloaded to the simulators over network 28, or it may alternatively be supplied on tangible media, such as CD-ROM.

Preferably, each of simulators 22, 24, 26 maintains a dedicated communication thread for each of its links (in the simulated network) with each of the other simulators. This thread is responsible for the communications among the simulators over network 28. As described further hereinbelow, each of the dedicated threads reads input data from an input file in a memory 30 and passes the input data to its respective simulator for processing. At the same time, the thread collects output data generated by the respective simulator for transmission over its particular link and writes the data to an output file in memory 30. This output file serves as the next input file for another of the simulators. Typically, memory 30 comprises one or more disks, which may be local to one or more of the participating simulators, or may be located at a remote location accessible via network 28. Remote reading and writing to memory 30 may be carried out using any suitable method known in the art, such as the well-known File Transfer Protocol (FTP). Alternatively, the threads may exchange frames of input and output data using communication sockets, as provided by protocols known in the art, such as Transport Control Protocol/Internet Protocol (TCP/IP) sockets.

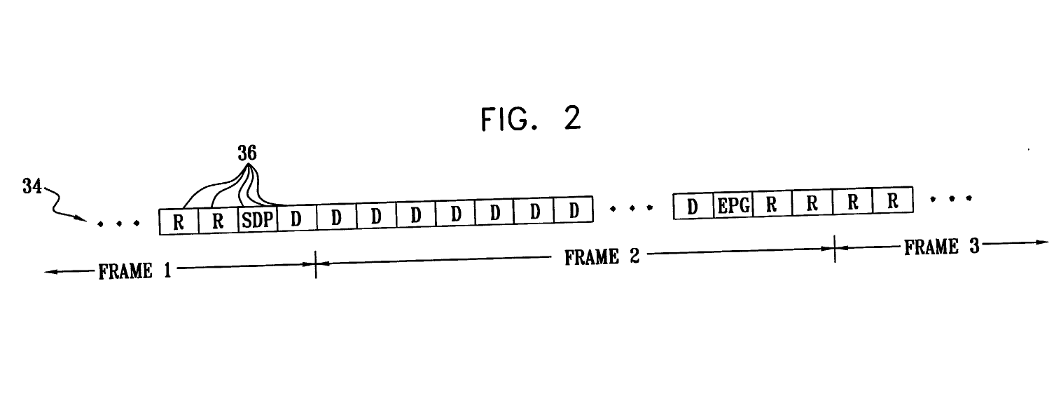

FIG. 2 is a simplified timing diagram that schematically illustrates a method of data framing used in communications among simulators 22, 24 and 26, in accordance with a preferred embodiment of the present invention. A given simulator (say simulator 22) generates a stream 34 of data symbols 36. In the case of parallel InfiniBand links, for example, symbols 36 comprise ten bits each. A data packet transmitted in an InfiniBand network typically begins with a start-packet delimiter symbol, marked “SDP” in FIG. 2, and ends with an end-packet delimiter symbol, marked “EGP.” In between these two delimiters, the packet contains data symbols, marked “D.” On the other hand, when a given InfiniBand device has no packet data to send, it simply transmits default (random) data symbols, marked “R,” to maintain link timing. Symbols 36 are generated at a link clock rate that is specified by the applicable standard.

The dedicated communication thread running on simulator 22 gathers the output symbols generated by the simulator into frames, marked “FRAME 1,”“FRAME 2,” etc., in FIG. 2. Each frame contains a fixed number of symbols, which is given by a configurable parameter, SymbolPerFile. Thus, there is generally no correspondence between the boundaries of the data packets exchanged by the simulated devices and the boundaries of the data frames, or files, exchanged by the communication threads of the simulators.

The latency of communications over the simulated network is modeled in system 20 using two preset parameters: SymbolPerFile, as noted above, and FileNumber. Files received by each of the simulators from the other are held in memory 30, either locally or remotely, as described above. The maximum number of input files that can exist in the memory for each of the simulators is determined by FileNumber. In other words, at any time there may be up to FileNumber files received from the other simulator and waiting to be read. If this number is exceeded on the link from simulator 22 to simulator 24, for example, simulator 22 will wait to create any more output files until simulator 24 has finished processing its oldest input file in the memory.

FIG. 3 is a flow chart that schematically illustrates a method for co-simulation of two or more devices modeled in system 20, in accordance with a preferred embodiment of the present invention. For the sake of example, the method will be described with reference to a device modeled by simulator 22, in interaction over a simulated packet network with another device modeled by simulator 24. Simulators 22 and 24 exchange data files over simulation network 28 through memory 30. As illustrated in FIG. 2, above, each file contains a sequence of symbols, corresponding to the data output by the simulated device during successive cycles of the simulated link between the modeled devices.

The method of FIG. 3 begins with an initialization step 40, at which simulator 22 creates a number of default output files containing default symbols, such as the random data symbols shown in FIG. 2. Preferably, the number of default files is one less than the FileNumber setting. Simulator 22 sends these default files over network 28 to simulator 24, and waits to receive its first input file from simulator 24, at an initial file reception step 42. When the first input file is ready, simulator 22 begins to read the symbols from the first input file, at a reading step 44. The simulator runs a simulation cycle in which it processes the symbol, along with preceding symbols, as appropriate, at a processing step 46. The result of the simulation cycle is an output symbol, which the simulator writes to the next output file, at a writing step 48. Steps 44, 46 and 48 are repeated until all of the symbols have been read out of the input file (a number of symbols equal to the SymbolPerFile parameter), and the same number of symbols has been written to the output file, at a file completion step 50. Simulator 22 then erases the input file that it has finished reading from memory 30, at an erasure step 52. Simulator 24 performs a comparable step when it finishes reading one of its input files, which are the output files generated by simulator 22.

Before beginning to process the next input file, simulator 22 verifies that simulator 24 is prepared to receive the next output file, at a file verification step 54. For example, assuming FileNumber=3, simulator 22 will have sent output files 0 and 1 at step 40, and received input file 0 at step 42. At each iteration through step 48, simulator 22 will have written another symbol to output file 2, so that at step 50, simulator 22 will have finished writing SymbolPerFile symbols to the output file. Each subsequent output file is numbered consecutively in modulo(FileNumber). Thus, at step 54, simulator 22 verifies that output file 0 does not exist in memory 30, i.e., that this file has been entirely read and erased by simulator 24.

If the next output file still exists (file 0 in the present example), simulator 22 waits a predetermined period, at a wait step 56, to allow simulator 24 to finish processing the oldest existing file. Any suitable method known in the art can be used to suspend the simulation process temporarily. For example, in Unix-based systems, the “SLEEP” command can be used to suspend the process for a specified number of seconds. Once simulator 22 has verified that the next output file (output file 0) no longer exists in memory 30, simulator 22 opens its next input file for reading (input file 1), at a next input step 60. It then begins processing the new input file at step 44, and writing to the new output file 0 at step 48, as described above. This cycle continues indefinitely thereafter, until the simulation is done.

While the method of FIG. 3 is described hereinabove, for the sake of simplicity, with reference only to exchange of files between simulators 22 and 24, this method may be extended, mutatis mutandis, to include communications with simulator 26, as well as with additional simulators. Communication links and simulation parameters among these simulators should reflect the topology and other pertinent conditions of the simulated network. Simulators 22, 24 and 26 may represent device models at different levels of abstraction, including high-level models, logic-design models written in HDL (hardware description language) and verification stubs. Furthermore, the role of one of the simulators may be played by a test generator, which can be used to send data to the other simulators that is representative of difficult or abnormal conditions, in order to verify that the simulated devices are able to cope properly with these conditions. The extensions necessary to the method of FIG. 3 for implementing these alternative embodiments of the present invention will be apparent to those skilled in the art.

It will be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for simulation, comprising:
establishing a network connection between first and second simulators, which are respectively configured to simulate operation of first and second devices in mutual communication over a link having a link clock;
receiving at the first simulator an input frame sent over the network connection, the input frame comprising input data generated by the second simulator in the course of the simulated operation of the second device over multiple cycles of the link clock for transmission via the link to the first device;
processing the input data using the first simulator to simulate the operation of the first device over multiple cycles of the link clock and thus to generate an output frame comprising output data; and
passing the output frame from the first simulator to the second simulator over the network connection for processing by the second simulator in the simulated operation of the second device.

2. A method according to claim 1, wherein establishing the network connection comprises establishing the connection over a local area network (LAN).

3. A method according to claim 1, wherein the first and second simulators are located at respective sites, remote from one another, and wherein establishing the network connection comprises establishing the connection between the sites.

4. A method according to claim 3, wherein establishing the connection comprises establishing the connection over the Internet.

5. A method according to claim 1, wherein the first and second simulators are configured to simulate the first and second devices using substantially different, respective first and second simulation software tools.

6. A method according to claim 5, wherein the first simulation tool comprises a hardware design language tool, while the second simulation tool comprises a high-level performance evaluation modeling tool.

7. A method according to claim 5, wherein the first simulation tool comprises a device simulator, while the second simulation tool comprises a test generator, which is configured to generate the input data so as to verify behavior of the first device.

8. A method according to claim 1, wherein the first and second simulators are operated respectively by different first and second business entities in development of the first and second devices.

9. A method according to claim 1, wherein receiving the input frame comprises receiving a file, and wherein the input data comprise input symbols arranged in sequence in the file.

10. A method according to claim 9, wherein the output frame comprises an output file, and the output data comprise output symbols, and wherein processing the input data comprises reading, at each of the cycles of the link clock in the simulated operation of the first device, one of the input symbols from the input file, and writing one of the output symbols to the output file.

11. A method according to claim 10, wherein passing the output frame comprises passing the output file after the first simulator has written a predetermined number of the symbols to the output file.

12. A method according to claim 1, wherein establishing the network connection comprises opening a communication socket, and wherein receiving the input frame and passing the output frame comprise receiving and passing the frames using the socket.

13. A method according to claim 1, wherein processing the input data comprises generating the output data over a number of the cycles of the link clock that is selected responsive to a latency of the mutual communication between the first and second devices in the simulated operation thereof.

14. A method according to claim 1, wherein receiving the input frame comprises receiving an input succession of input frames, and wherein processing the input data comprises generating an output succession of output frames, and wherein passing the output frame comprises passing the output frames in the output succession while receiving the input frames in the input succession.

15. A method according to claim 14, wherein receiving the succession of input frames comprises holding at least a second one of the input frames in a memory while processing a first one of the input frames.

16. A method according to claim 1, wherein receiving the input frame comprises receiving input frames from a plurality of other simulators, including the second simulator, and wherein processing the input data comprises generating multiple output frames, and wherein passing the output frame comprises passing the output frames to the plurality of other simulators.

17. A method for simulation, comprising:
establishing a network connection between first and second simulators operated respectively by different first and second business entities in development of first and second devices, the first and second simulators being respectively configured to simulate operation of first and second devices in mutual communication over a link;
receiving at the first simulator an input frame sent over the network connection, the input frame comprising input data generated by the second simulator in the course of the simulated operation of the second device for transmission via the link to the first device;
processing the input data using the first simulator to simulate the operation of the first device and thus to generate an output frame comprising output data; and
passing the output frame from the first simulator to the second simulator over the network connection for processing by the second simulator in the simulated operation of the second device.

18. A method according to claim 17, wherein establishing the network connection comprises establishing the connection between facilities of the first and second business entities.

19. A method according to claim 17, wherein establishing the network connection comprises linking the first and second simulators substantially without divulging confidential information embodied in a simulation model of the first device run by the first simulator to the second business entity.

20. A method according to claim 17, wherein establishing the connection comprises establishing the connection over the Internet.

21. A method according to claim 17, wherein the first and second simulators are configured to simulate the first and second devices using substantially different, respective first and second software tools.

22. A method according to claim 17, wherein receiving the input frame comprises receiving an input succession of input frames, and wherein processing the input data comprises generating an output succession of output frames, and wherein passing the output frame comprises passing the output frames in the output succession while receiving the input frames in the input succession.

23. Simulation apparatus, comprising a first simulation processor, which is configured to simulate operation of a first device and is adapted to establish a network connection with a second simulation processor, configured to simulate operation of a second device, so as to model communication between the first and second devices over a link having a link clock, the first simulation processor being further adapted to receive an input frame sent over the network connection, the input frame comprising input data generated by the second simulation processor in the course of the simulated operation of the second device over multiple cycles of the link clock for transmission via the link to the first device, to process the input data so as to simulate the operation of the first device over multiple cycles of the link clock and thus to generate an output frame comprising output data, and to pass the output frame to the second simulation processor over the network connection for processing by the second simulation processor in the simulated operation of the second device.

24. Apparatus according to claim 23, wherein the network connection comprises a connection over a local area network (LAN).

25. Apparatus according to claim 23, wherein the first and second simulation processors are located at respective sites, remote from one another, and wherein the network connection comprises a connection between the sites.

26. Apparatus according to claim 25, wherein the connection between the sites is established over the Internet.

27. Apparatus according to claim 23, wherein the first and second simulation processors are configured to simulate the first and second devices using substantially different, respective first and second software tools.

28. Apparatus according to claim 27, wherein the first simulation tool comprises a hardware design language tool.

29. Apparatus according to claim 27, wherein the first simulation tool comprises a high-level performance evaluation modeling tool.

30. Apparatus according to claim 27, wherein the second simulation tool comprises a test generator, which is configured to generate the input data so as to verify behavior of the first device.

31. Apparatus according to claim 23, wherein the first and second simulation processors are operated respectively by different first and second business entities in development of the first and second devices.

32. Apparatus according to claim 23, wherein the input frame comprises a file, and wherein the input data comprise input symbols arranged in sequence in the file.

33. Apparatus according to claim 32, wherein the output frame comprises an output file, and the output data comprise output symbols, and wherein the first simulation processor is adapted to read, at each of the cycles of the link clock in the simulated operation of the first device, one of the input symbols from the input file, and to write one of the output symbols to the output file.

34. Apparatus according to claim 33, wherein the first simulation processor is adapted to pass the output file after it has written a predetermined number of the symbols to the output file.

35. Apparatus according to claim 23, wherein the network connection comprises a communication socket opened between the first and second simulation processors, and wherein the input frame is received and the output frame is passed using the socket.

36. Apparatus according to claim 23, wherein the first simulation processor is arranged to generate the output data over a number of the cycles of the link clock that is selected responsive to a latency of the mutual communication between the first and second devices in the simulated operation thereof.

37. Apparatus according to claim 23, wherein the input frame is one in an input succession of input frames, and the output frame is one in an output succession of output frames, and wherein the first simulation processor is arranged to receive the input succession of input frames and to generate and pass the output succession of output frames while receiving the input frames in the input succession.

38. Apparatus according to claim 37, and comprising a memory, which is adapted to hold at least a second one of the input frames while the first simulation processor processes a first one of the input frames.

39. Apparatus according to claim 23, wherein the input frame is one of a multiplicity of input frames received by the first simulation processor from a plurality of other simulation processors, including the second simulation processor, and wherein the first simulation processor is adapted to generate multiple output frames and to pass the output frames to the plurality of other simulation processors.

40. Apparatus for simulation, comprising first and second simulators operated respectively by different first and second business entities in development of first and second devices, the first and second simulators being connected by a network connection and being respectively configured to simulate operation of first and second devices in mutual communication over a link, such that upon receiving over the network connection an input frame comprising input data generated by the second simulator in the course of the simulated operation of the second device for transmission via the link to the first device, the first simulator is adapted to process the input data to simulate the operation of the first device and thus to generate an output frame comprising output data, and to pass the output frame to the second simulator over the network connection for processing by the second simulator in the simulated operation of the second device.

41. Apparatus according to claim 40, wherein the network connection is established between facilities of the first and second business entities.

42. Apparatus according to claim 40, wherein the first and second simulators are connected substantially without divulging confidential information embodied in simulation models of the devices from one of the business entities to the other.

43. Apparatus according to claim 42, wherein the connection is established over the Internet.

44. Apparatus according to claim 40, wherein the first and second simulators are configured to simulate the first and second devices using substantially different, respective first and second simulation software tools.

45. Apparatus according to claim 40, wherein the input frame is one in an input succession of input frames, and wherein the output frame is one in an output succession of output frames, and wherein the first simulation processor is arranged to pass the output frames in the output succession while receiving the input frames in the input succession.

46. A computer software product, comprising a computer-readable medium in which program instructions are recorded, which instructions, when read by a first computer simulating operation of a first device, cause the computer to establish a network connection with a second computer, simulating operation of a second device, so as to model communication between the first and second devices over a link having a link clock, so that upon receiving an input frame sent over the network connection, the input frame comprising input data generated by the second computer in the course of the simulated operation of the second device over multiple cycles of the link clock for transmission via the link to the first device, the first computer processes the input data to simulate the operation of the first device over multiple cycles of the link clock and thus to generate an output frame comprising output data, and passes the output frame to the second computer over the network connection for processing by the second computer in the simulated operation of the second device.

47. A computer software product, comprising a computer-readable medium in which program instructions are recorded, which instructions, when read by a first computer operated by a first business entity in development of a first device, cause the first computer to establish a network connection with a second simulator operated by a different, second business entity in development a second device, the first and second computers being respectively configured to simulate operation of the first and second devices in mutual communication over a link, so that upon receiving an input frame sent over the network connection, the input frame comprising input data generated by the second computer in the course of the simulated operation of the second device for transmission via the link to the first device, the first computer processes the input data to simulate the operation of the first device and thus to generate an output frame comprising output data, and passes the output frame to the second computer over the network connection for processing by the second computer in the simulated operation of the second device.
